(19) United States
(12) Patent Application Publication
(10) Pub. No.: US 2012/0034354 A1
(43) Pub. Date: Feb. 9, 2012

(54) Food Heating System

(76) Inventors: Ken Board, Swansea (GB); Alun Rhys Board, Swansea (GB)

(21) Appl. No.: 13/202,818

(22) PCT Filed: Feb. 22, 2010
(86) PCT No.: PCT/GB10/00318

§ 371 Date: Oct. 24, 2011

(30) Foreign Application Priority Data
Feb. 23, 2009 (GB) 0903018.0

(51) Int. Cl. A47J 27/62; A23L 1/01; B65D 81/34; A23L 1/00

(52) U.S. Cl. 426/392; 99/483; 426/509

(57) ABSTRACT

A food heating system has a container within which the food is to be heated. The food heating system also has a heater means for heating either or both of the food present in the container or a fluid heating medium present in the container. At least part of either or both of the food present in the container or the fluid heating medium is in the liquid phase. The heater means is controlled so as to not raise the temperature of the fluid heating medium to the boiling point of the liquid present in the container. Further, the pressure within the container is increased so as to raise the boiling point of the liquid within the container. The food heating system causes the cooking period of the foodstuff to be reduced and reduces the amount of energy required to heat the foodstuff.

### CROSS-REFERENCE TO RELATED APPLICATIONS

This application claims priority from PCT/GB/2010/000318 filed on Feb. 22, 2010 and from GB 0903018.0, filed Feb. 23, 2009, which are hereby incorporated by reference in their entireties.

### BACKGROUND OF THE INVENTION

1. Field of the Invention

This invention relates generally to a food heating system.

2. State of the Art

In general, foods such as vegetables are cooked using a conventional saucepan on a cooker ring. The food is placed inside the saucepan and immersed in a fluid (typically a liquid) such as, for example, water, oil or milk which is heated to a temperature such that the food may be heated or cooked. Where certain fluids are used such as water, the fluid may be heated to its boiling point. The temperature of the fluid is sustained for the required time until the food is cooked. The cooked food is then removed from the saucepan and the water is disposed of.

There are a number of disadvantages associated with the conventional method of cooking food. Where cooking with boiling water, the amount of water used to boil, for example, vegetables in a saucepan is greatly in excess of the minimum water required. Secondly, the water has a large thermal capacity and the thermal energy stored is also large and is generally discarded after cooking is achieved. Finally, the energy required to boil the water, related to the latent heat of vaporisation, is also large. Such energy is lost in the form of latent heat of vaporisation, such as in the formation of steam when cooking with boiling water. As a consequence significant time and energy is required to achieve the end result of cooking the vegetables.

U.S. Pat. No. 5,586,487 describes a device and method for automatically cooking and draining food, for example pasta, rice or noodles. The device consists of an outer housing made of an electrically and thermally non-conductive material that stores water at its base and uses a central conduit to transfer hot water, heated by the heating element at its base, to the top of the container where it showers the food that is stored in the food retaining means. This process is continuous and, along with a slight positive cooking pressure, is used to cook the food for a pre-set amount of time.

International Patent Application No. WO 00/10440 describes a turkey baster consisting of a container in which the meat is placed, with at least one tube extending from the container having a top end coupled to a perforated plate, whereby the holes at the base of said perforated plate are raised such that the liquid substantially covers the plate before draining onto the meat.

While the systems described above are effective in providing the means to cook food there is a constant drive to reduce the amount of time and energy to achieve the end result. For example, the showering technique in U.S. Pat. No. 5,586,487 may not distribute the water evenly over the food stored in the food retaining means, causing the food to be cooked at different rates. As a result, the water may need to be heated for longer and some of the food may be overcooked.

International Patent Application No. WO 00/10440 improves on the distribution of the liquid over the food, but at the expense of using excess liquid, which is stored on a top plate.

### SUMMARY OF THE INVENTION

It is an object of the present invention to provide an improved cooking device for cooking food that enables the amount of liquid required to be minimised. As a consequence, the amount of energy required to achieve the end result is reduced.

In accordance with the present invention, there is provided a food heating system comprising:
a container within which the food is to be heated;
heater means for heating either or both of the food present in the container or a fluid heating medium present in the container, at least part of either or both of the food present in the container or the fluid heating medium being in the liquid phase;
wherein the heater means is controlled so as to not raise the temperature of the fluid heating medium to the boiling point of the liquid present in the container.

In a first embodiment the fluid heating medium is in the liquid phase.

In a preferred embodiment, the control means is arranged to control the temperature of the heating element so as not raise the temperature of the heating element to the boiling point of the cooking liquid in the container. This reduces the risk of significant energy being lost by causing boiling ‘hotspots’ at the heating element.

It is preferred, where water is used as the cooking liquid, that the control means is arranged to inhibit the temperature of the water from reaching 100° C.

Desirably, the control means is arranged to operate the heater element to maintain the temperature of the liquid at or above a predetermined threshold. In one preferred embodiment it is preferred that the control means is arranged to operate the heater element to maintain the temperature of the liquid at or above a level 20° C. below the boiling point of the liquid. In one preferred embodiment it is preferred that the control means is arranged to operate the heater element to maintain the temperature of the liquid at or above a level 10° C. below the boiling point of the liquid.

It is preferred that the apparatus further includes agitating means for agitating the liquid in the container.

According to a further aspect, the invention therefore provides food heating apparatus comprising;
a container for containing liquid and being heated;
agitating means for agitating the liquid in the container whilst being heated.

The container preferably has means for transmitting heat to the liquid in the interior of the container.

In one embodiment, the agitating means may beneficially comprise means for directing an agitating fluid into the container to agitate the liquid in the container. Such an arrangement may beneficially comprise means for directing an agitating gas, such as air (preferably under pressure) from externally of the container, into the container, in order to agitate the liquid in the container. A conduit or other means may be provided for directing an agitating fluid under pressure into the container, preferably to an outlet in the region of the base of the container. The agitating fluid, such as air or otherwise, is preferably heated (in order to avoid cooling the liquid in the container) and preferably directed under pressure into the container below the level of the liquid present in the container.

Beneficially, the apparatus includes means for distributing the liquid over the surface of foodstuff present in the container. This may simply be the action of the agitating means in causing agitated motion of the liquid in the container.

In one embodiment, a food receiving receptacle is located within the container, and the distribution arrangement directs the liquid to flow over a side of the food receiving receptacle and through a percolation element placed above the foodstuff heating zone.

The enclosure may be defined by a sidewall (or sidewalls) extending about the food heating zone and extending upwardly for an extent that rises above the level of the food situated at the heating zone. In one embodiment the enclosure is defined by the wall or walls of the container. In an alternative embodiment the enclosure may be defined by the wall or walls of a food receiving receptacle placed in the container. The enclosure may be capped by a lid or the percolation element (acting as a lid) or a lid or cover provided above the percolation element. It is preferred that the enclosure sidewall (or sidewalls) extend upwardly to substantially the position of the percolation element or above.

In a preferred embodiment the liquid distribution arrangement comprises a base portion arranged to rest on the container base. The base portion may provide a platform upon which the food to be heated may rest.

Preferably, the base portion is provided with one or more liquid communication conduits permitting liquid communication via the base from the container to the liquid distribution arrangement.

The system preferably provides one or more conduits for raising the water from a lower portion of the container to be distributed from above the food heating zone.

In one embodiment, the one or more conduits are defined at the periphery of the liquid distribution arrangement.

In one embodiment, a food receiving receptacle is located within the container, and the distribution arrangement comprises a conduit in the form of an annular space between the food receiving receptacle and the container.

In another embodiment, the system includes an upwardly extending annular wall and the liquid distribution arrangement comprises a plurality of upwardly extending conduits spaced about, and provided internally of, the annular wall.

In a still further embodiment, the food receiving receptacle is located within the container, and the distribution arrangement comprises a channels defined by a fluted or castellated surface provided for one or both of the food receptacle and the container at the interface between the food receiving receptacle and the container.

In a still further embodiment, the distribution arrangement may comprise a central column up which the fluid is raised to be dispensed outwardly.

In accordance with a further aspect, the invention provides a method of heating food in which liquid is heated in a container, the liquid being maintained at a temperature below the boiling point of the liquid, and the liquid is agitated by an agitation means.

Beneficially, the liquid is agitated by means delivering into the liquid a pressurised fluid from externally of the liquid in the container. An agitating gas stream may be delivered to agitate the liquid in the container.

A further aspect of the present invention provides a method of heating food in which liquid is heated in a container, and the liquid is agitated by delivering into the liquid a pressurised fluid from externally of the liquid in the container.

The container may comprise a saucepan configured to be used on a conventional cooker ring. Alternatively the container may comprise a thermally insulating, waterproof vessel and, optionally, the device may have an integrated heating element such that a conventional hob is not required. In yet another exemplary embodiment, the container may comprise a microwavable container to be heated with a microwave oven.

To operate the cooking device according to one aspect of the invention, a liquid reservoir in the container is heated and regulated at a specific temperature which is below the boiling point of the liquid, although high enough to effect a heating/cooking process on the foodstuff. Additionally, or in accordance with an alternative aspect of the invention, pressurised air or other agitation means causes bubbles in the liquid which force liquid up the liquid delivery arrangement to be distributed over the food heating zone.

In one embodiment, the liquid may be distributed in droplet form such as a spray or mist in the container. Pressurised gas or other pumping means may be arranged to distribute the liquid in the form of a spray.

In a next embodiment the container is closed and sealed and capable of withstanding pressures above and/or below atmospheric pressure from given altitude. Further the container is thermally insulated. There is provided means for increasing the pressure internal to the container and at least one control means is arranged for controlling the pressure within the container.

Preferably there is included at least one inlet located in at least one side of the container and positioned above the foodstuff for permitting the injection of fluid heating medium into the container causing the fluid heating medium to pass over the foodstuff. This ensures that the fluid heating medium makes contact with the foodstuff. It is also preferable to include at least one outlet located in at least one side of the container for permitting the extraction of fluid heating medium from the container. A fluid heating medium transporting means is arranged between the outlet and the inlet to direct the fluid heating medium there between. A pump means is used for pumping the fluid heating medium through the fluid heating medium transporting means.

In a preferred embodiment the fluid heating medium transporting means is terminated by a spray head that is used to mix gas and liquid prior to the liquid being transported across the foodstuff. This provides a uniform distribution of the heated fluid heating medium across the foodstuff.

In an alternative embodiment there is included a gas inlet for permitting the injection of gas into the container so as to increase the number of gas particles within a given volume and causing a positive pressure within the container.

In a further embodiment there is included mechanical means for adjusting the volume within the container, preferably the volume is decreased so as to increase the pressure within the container. This adjustment of the volume within the container may also be achieved by including a means by increasing the volume of the liquid phase and/or the fluid heating medium within the container so as to reduce the volume in which the gas resides.

In a further embodiment the pressure within the container may be adjusted by including a further means for heating the gas and/or liquid contained within the container. This further heating means is used to increase the energy of the gas particles within in the container so as to create a positive pressure within the container.

Desirably there is included at least one sensing means for sensing one or more of temperature, pressure or flow rate within the system. The output of the sensing means is integrated in a feedback loop which enables the control unit to regulate the system parameters by means of at least one feedback loop.

A further aspect to the present invention provides a method of heating food in which at least part of either or both of the food present in the container or the fluid heating medium present in the container being heated, at least part of either or both of the food present in the container or the fluid heating medium in the container being in the liquid phase, the fluid heating medium being maintained at a temperature below the boiling point of the liquid present in the container.

Preferably the pressure within the container is higher than atmospheric pressure outside the container. At least part of the pressure increase in the container being caused by the injection of gas particles into the container and/or is caused by decreasing the volume within the container and/or is caused by increasing the temperature of gas present within the container.

Desirably the fluid heating medium is removed from the container prior to being heated and is re-circulated through the heater until the moment at which the foodstuff is cooked.

In an alternative embodiment a predetermined amount of pre-heated fluid heating medium is injected into the container. The source of the fluid heating medium may be internal to the container or from a source external to the container.

In a preferred embodiment a predetermined amount of fluid heating medium is injected into the container via a heating means. The fluid heating medium can originate from a source external to the closed container or may be extracted from the closed container itself The container is laid aside for a period of time to allow the temperature within the container to become a uniform. The predetermined amount of fluid heating medium is dependent on the type of foodstuff present in the container.

Preferably the heated fluid heating medium is replenished when the temperature in the sealed container falls below a threshold value which can occur through conduction losses within the system and the threshold value may be predetermined or entered manually into the control unit.

Beneficially in an embodiment of the invention a flavour and/or nutritional additive is combined and mixed with the fluid heating means. This can be achieved by combining the additive with the liquid in an external reservoir or by combining the liquid and additive within the system. For example lemon juice or other type of flavouring could be added to the liquid, along with a vitamin and/or mineral additive so as to improve the flavour and/or nutritional content of the foodstuff.

In a further embodiment the fluid heating medium is in a gaseous phase in which the gas is stored within a closed container, wherein the gas is pumped out of the closed container prior to being heated by heater means, the heated fluid subsequently being returned to the closed container and then distributed over the surface of foodstuff present within the closed container.

Preferably the temperature of the gasses phase being maintained at a temperature below the boiling point of water contained in the foodstuff.

In a further embodiment the fluid heating medium is gas comprising droplets of liquid phase.

Advantages of the device according to an embodiment of the invention include that the amount of water used is only that required to flow over the foodstuff in a continuous stream and then to be recycled.

Additionally the cooking time is comparable with the time taken to boil the water as required in the standard cooking method. Therefore the food is cooked more quickly using a device according to the invention. This, along with the fact a reduced amount of water may be used, reduces the amount of energy required to heat the foodstuff. Also, flavour and vitamin retention of the food can be enhanced if cooking occurs at a temperature slightly below boiling.

These and other aspects of the invention will be apparent and elucidated with reference to the embodiments described herein.

Various embodiments of the invention will now be described, by way of examples only and with reference to the accompanying drawings.

### BRIEF DESCRIPTION OF THE DRAWINGS

FIG. 1 is a schematic illustration showing the cross sectional front view of a first embodiment of a cooking arrangement according to the invention;

FIG. 2a is a schematic plan view of the percolation channel of the arrangement of FIG. 1;

FIG. 2b is a schematic plan view illustrating the percolation channels of a food heating system according to an alternative exemplary embodiment of the invention;

FIG. 3 is a schematic view of an alternative embodiment of a food heating system in accordance with the invention;

FIG. 4 is a schematic view of a further alternative embodiment of a food heating system in accordance with the invention;

FIG. 5 is a schematic partial view of an alternative embodiment of a food heating system in accordance with the invention.

FIG. 6 is a schematic view of an alternative embodiment of a food heating system in accordance with the invention.

FIG. 7 is a schematic view of an alternative embodiment of a food heating system in accordance with the invention.

FIG. 8 is a schematic view of an alternative embodiment of a food heating system in accordance with the invention.

FIG. 9 is a schematic view of an alternative embodiment of a food heating system in accordance with the invention.

FIG. 10 is a schematic view of an alternative embodiment of a food heating system in accordance with the invention.

### DETAILED DESCRIPTION OF THE PREFERRED EMBODIMENTS

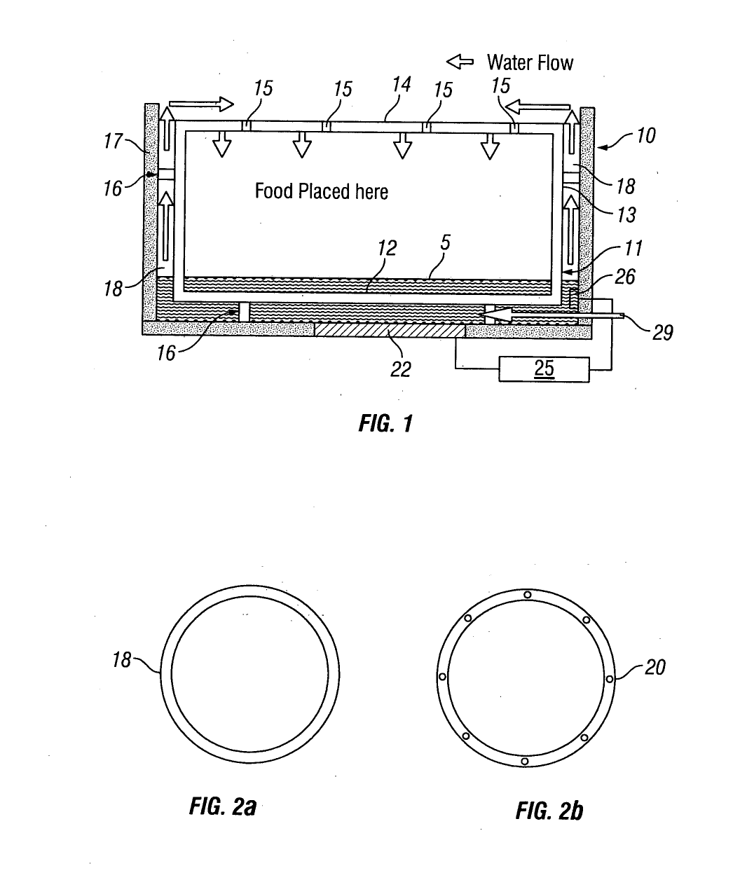

Referring to FIG. 1 of the drawings, the food heating system 10 consists of an outer container 17 and seated in the outer container 17, receptacle 11 comprising a circular flat base plate 12 having at least one drain aperture between the upper and lower sides of the base plate. At the outer perimeter of the base plate 12, is a sidewall 13 orientated such that it extends upwards from the base plate 12. A detachable flat circular percolation plate 14, having a plurality of percolation apertures 15, is positioned parallel to the base plate 12 seated on the top edge of the side wall 13. The outer periphery and base of the receptacle has a plurality of protruding elements 16. When fitted in the container 17, the outer edge of the receptacle forms the inner edge of a channel 18, with the inner edge of the container forming the outer edge of the channel 18, said outer edge of the channel extending further in the upwards direction than the inner edge of the channel. As shown in FIG. 2a, this results in an annular gap of uniform width (viewed from above). The annular gap is sufficiently small (typically less than 0.5 cm) that when the water is pumped either by a specific pump (not shown) or agitated by introduction of a pressurised stream of heated air via a conduit 29, the water 5 rises up the annular gap defining channel 18 and then spreads out over the perforated top plate 14, the hot water percolating down through the apertures 5 and contacting the food to be heated in the food heating zone below the top plate 14. The water then passes through the aperture or apertures in the base plate 12 and into the water reservoir defined by the container 17, for recirculation. A stand (not shown) may rest on the base plate 12 to raise the food above the level of the base plate.

The container 17 is provided with its own heater element (such as an electric heater element 22 for heating the water in the container). This may be electronically controlled by means of a controller 25 operating on feedback from a temperature sensor 26 such that the temperature of the water in the container is maintained in a permitted window or region, which is one embodiment, in which the arrangement is controlled so as not to permit boiling of the water in the container, typically in the range 80° C. to 100° C.

A lid (not shown) may be provided to rest on the top of the container 17. This has been found to aid in the distribution of water over the top plate 14 and provide protection against splashing and spurting of the hot water passing up the annular channel 18.

In an alternative exemplary embodiment, and referring to FIG. 2b of the drawings, the percolation channels 20 may be provided distributed around the periphery of the receptacle 11 integrally within the sidewalls 13 of the receptacle 11 (which may or may not then be spaced apart from the inner periphery of the outer container 17).

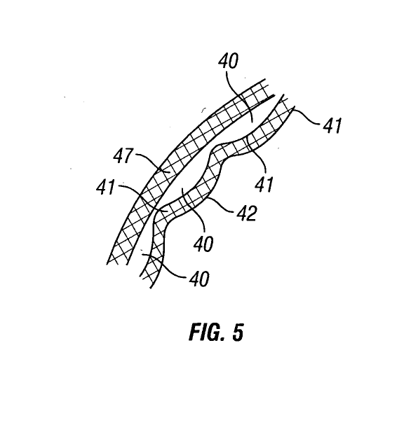

In a further embodiment as shown in FIG. 5, the channels 40 may be defined by flutes 41 formed in the outer surface of the inner receptacle 42 which is received in the outer container 47. Alternatively castellations may be provided, and the formations could be formed in the inner surface of the outer container 47 in addition to (or as an alternative to) the inner receptacle 42 the frictional contact between the inner receptacle and outer container at the flutes or castellations aids in holding the inner receptacle in place during cooking in turbulent agitated liquid. Utilisation of a lid for the system also aids in this.

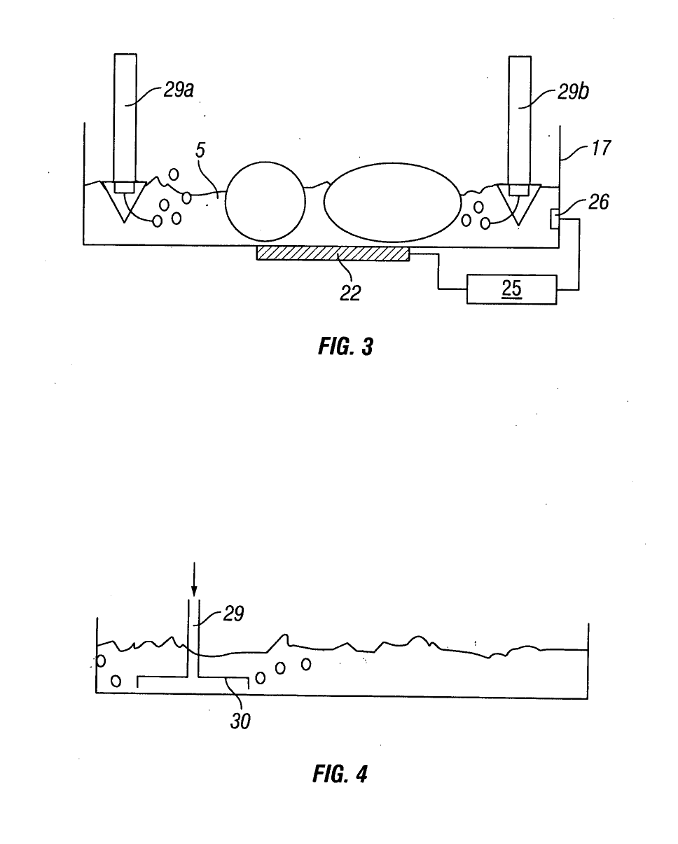

In the embodiment of FIG. 3, the container 17 is partially filled with water 5 and 2 air delivery conduits 29a, 29b deliver pressurised heated air to below the level of the water surface in order to effect agitation of the heated water in the container. The air supply may be controlled (pressure and/or volume flow) to control the degree of agitation of the water in the container. At one extreme severe agitation may cause the foodstuffs to move within the container (which may in certain circumstances be desirable). At the other extreme gentle bubble formation may be sufficient to cause the desired agitation and lapping of the water in the container. The container 17 is provided with its own heater element (such as an electric heater element 22 for heating the water in the container). This may be electronically controlled by means of a controller 25 operating on feedback from a temperature sensor 26 such that the temperature of the water in the container is maintained in a permitted window or region, which is one embodiment, in which the arrangement is controlled so as not to permit boiling of the water in the container, typically in the range 80° C. to 100° C. FIG. 4 shows an alternative means of delivering air into the water in the container via a heated air conduit 29 terminating in a plenum 30 provided with peripheral outlet apertures.

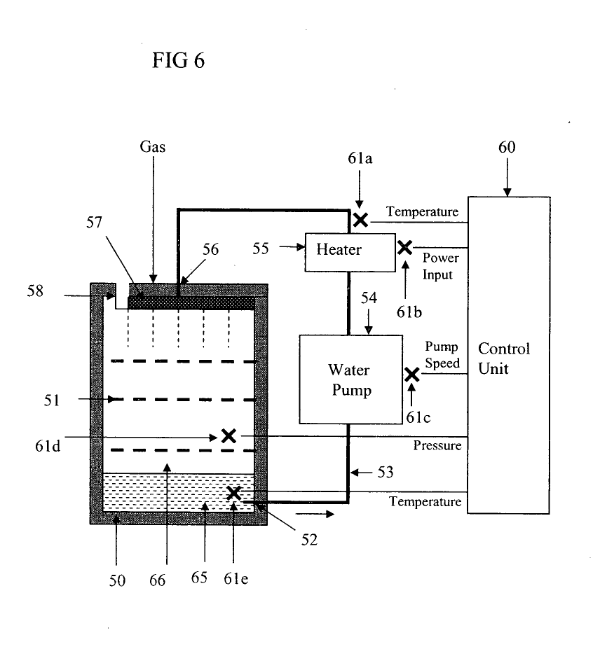

In the embodiment of FIG. 6 there is provided a thermally insulated, sealed container 50 filled with gas 66 and a liquid reservoir 65. The liquid reservoir could comprise, for instance, water or milk and is the fluid heating medium of the system. A section of the outer wall of the sealed container may be unsealed and removed, so as to permit the placement of foodstuff within the container and for transferring liquid to the reservoir. Once the foodstuff is positioned within the container, the section of the outer wall is refitted and re-sealed prior to the operation of the cooking device. In an alternative embodiment the sealed container is formed with a removable/resealable lid (not shown). The sealed container 50 is designed to withstand pressures above and/or below atmospheric pressure caused by the insertion or extraction of gas within the sealed container.

A pressure release safety valve 58 is located at the top of the sealed container 50 such that in the open state the valve permits the passage of gas from one side of the outer wall of the sealed container to the other. The flow of gas is dependent on the pressure differential of the gas between the interior and exterior of the container. Alternatively, the valve may be constructed to permit gas flow in a single direction only.

The sealed container 50 further comprises an outlet 52, preferably passing through the side wall of the sealed container and located near to the base of the container, and an inlet 56, preferably located at the top of the sealed container and adjacent to the safety valve 58.

Between the outlet 52 and inlet 56 there is arranged a fluid heating medium transporting means 53 to permit the passage of liquid there-between. The fluid heating medium transporting means can be in the form of a conduit e.g. a tube or a pipe. The tube 53 is intersected by a pump 54 and a heater means 55. The pump permits the distribution of liquid from the container through the heater and then through the inlet. A filter means (not shown) is positioned within the outlet.

A control unit 60 is provided and is connected to a range of sensors 61a, 61b, 61c and 61d located throughout the system. Sensor means can be used for monitoring the speed of operation of the pump, the pressure inside the container, the power provided to the heater means 55 and the temperature of the liquid between the heater means 55 and the inlet 56. It is noted that other parameters associated with the food heating system may also be monitored by a sensor means providing information via the controller to a control means e.g. the flow rate of liquid through the tube. The control unit may be hard wired or may be controlled by a microprocessor.

A spray head 57 is fixed to one end of the tube 53 and passes through the inlet 56 such that the apertures (not shown) of the spray head face the internal base of the container 50. In an alternative embodiment the tube passes through the aperture and the entire spray head 57, which is fixed to one end of the tube 53, is positioned within the sealed container 50. The spray head 57 can operate in different modes. The first mode merely permits the flow of water through the spray apertures (not shown) causing water droplets to fall through the sealed container 50 under the effect of gravity. The second, and preferable mode, mixes gas with the liquid in the spray head 57 so as to improve the spray performance and aid distribution of the liquid. The addition of gas in mode 2 will increase the pressure of the system as more gas molecules are introduced within the sealed container. The spray head is a flat type spray head, but may take other forms as desired. The spray head may cover either part of, or the entire cross sectional area of the upper surface of the sealed container. A single spray head 57 may be used, or alternatively multiple spray heads may be implemented, whereby the spray head comprises, or omits, a spray nozzle.

Internal to the sealed container 50 are positioned perforated trays 51 for containing food stuff. These may be stacked or may be fixed by an alternative means e.g. runners, and the arrangement may permit the removal of the perforated trays 51 from the sealed container 50. The inlet 56 is positioned at the top of the sealed container 50 such that heated liquid injected from the tube 53 and through the spray head 57 passes through the sealed container 50 so as to make contact with the foodstuff. The arrangement of the spray head 57 and the perforated trays 51 is optimised in order to permit an even distribution of the spray across the surface of the foodstuff.

The gas that is combined with the liquid in the spray head 57 may take several forms. This includes cold air, heated air, water vapour, air containing water droplets (spray) where the size of the water droplets vary from a very fine mist to a much coarser spray. Other gases may also be used such as nitrogen, oxygen or some mixture of these or other gases.

The control unit 60 is implemented to regulate the pressure and temperature of the liquid within the sealed container 50. Firstly, the user selects the desired temperature on the control unit 60, which is dependent on the foodstuff to be cooked. For example, a value of 107° C. may be selected. The control unit 60 selects the boiling temperature to be 3° C. above this, i.e. 110° C. and then uses a look up table to identify the pressure that corresponds to 110° C. Secondly, the duration of the cooking period is selected. The heated liquid mixed with gas is then injected via the spray head 57 into the sealed container 50 until the pressure reaches the selected value. The pressure is maintained for the selected cooking period and if necessary, further bursts of spray are injected. At the end of the cycle, the pressure valve 58 is opened to reduce the pressure within the container 50 and the cycle is completed. The pressure valve 58 may be operated throughout the heating procedure as a safety measure, as in the case of a standard pressure cooker.

In a first mode of operation liquid from the reservoir 65 is pumped out of the sealed container 50 through the outlet 52, the liquid then passes along the tube 53, through the pump 54, then back into the tube where the liquid reaches a heater means 55 for heating the liquid. The heated liquid travels onwards through the tube 53 until the liquid reaches the inlet 56 and the heated liquid is combined with a gas, e.g. air, in the spray head 57 so as to form spray that is injected into the sealed container 50. The liquid is heated in a region close to the spray head 57 so that there is no significant warm-up time involved in the process

As the spray passes across the surface of the foodstuff, which is positioned on the perforated trays 51, it imparts its heat to the foodstuff and water is released. The water falls to the bottom of the sealed container under gravity. This water is re-circulated through the filter, pump 54, the heater means 55 and back to the spray head 57. The cycle is repeated until the foodstuff is cooked. The filter (not shown) removes any food particles that have fallen into the water reservoir 65 during the process.

In a second mode of operation, a predetermined amount of liquid is extracted from the reservoir 65, circulated through the heater 55 and injected back into the sealed container 50. The amount of water extracted from the reservoir 65 is equivalent to the amount of heat needed to raise the foodstuff to the required temperature throughout its volume.

Therefore only a single extraction and injection of liquid is applied. The sealed container 50 is then left for a period of time so as to allow the temperature within the sealed container 50 to become uniform. This ensures that the contents of the sealed container are also raised to this uniform temperature. At this point the foodstuff can be regarded as being cooked. The sealed container is well insulated so that very little of the injected energy (in the form of heat) is lost to the surroundings external to the sealed container 50. However, because energy losses cannot be eliminated completely, it may be necessary to replenish the sealed container 50 with further bursts of liquid from the spray head 57. For example, further bursts would be implemented in the case that the temperature within the sealed container 50 falls below a threshold value that may be predetermined or entered manually into the control unit 60. In this second mode of operation there is no recirculation of the liquid.

The extraction of liquid from the sealed container may not be by means of a pump 54, and may, instead, be achieved by, for example, a diaphragm operated manually.

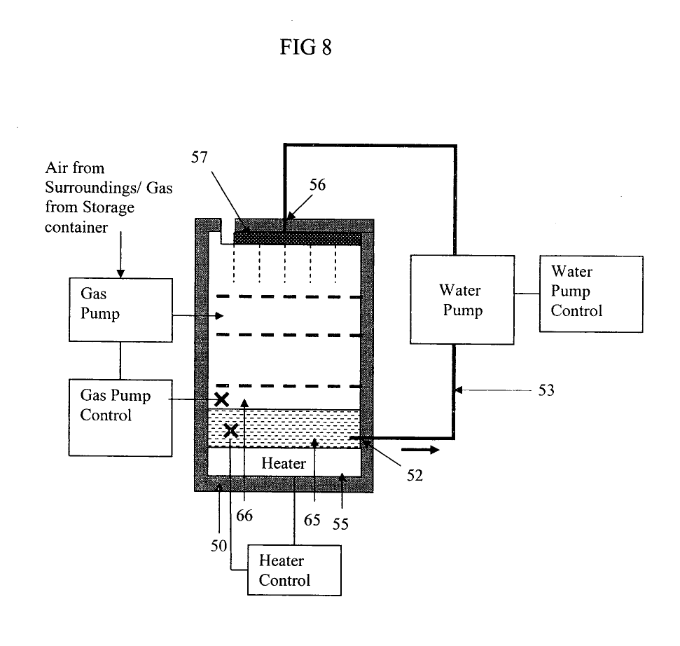

The heating method may take a number of forms including an electric heater element, microwave, induction heating or gas. Heating the liquid as it flows through the tube 53 provides an instantaneous supply of heated liquid, however it is also envisaged in an alternative embodiment, shown in FIG. 8, that a heater means 55 may be positioned inside the sealed container. When considering the embodiment of FIG. 8, it is noted that heat losses through conduction, on passage of the liquid through the delivery tube, can be minimised by the inclusion of insulation around the tubes (not shown). It should also be noted that there is a finite time associated with heating water in bulk in the embodiment of FIG. 8.

FIG. 8 further displays an embodiment of the invention including a gas inlet (not shown) whereby gas is pumped from an external source into the sealed container so as to create a positive pressure within the sealed container. The gas may be at room temperature or alternatively hot gas may be injected through the gas inlet (not shown) so as to energise the gas molecules and increase the pressure within the sealed container. The external source may be air or alternatively may be gas/spray stored in an external storage vessel.

In a further embodiment gas may be extracted from the sealed container enabling the option of obtaining a negative pressure internal to the sealed container (a reduced pressure within the container). The negative pressure could be provided so as to provide a partial vacuum.

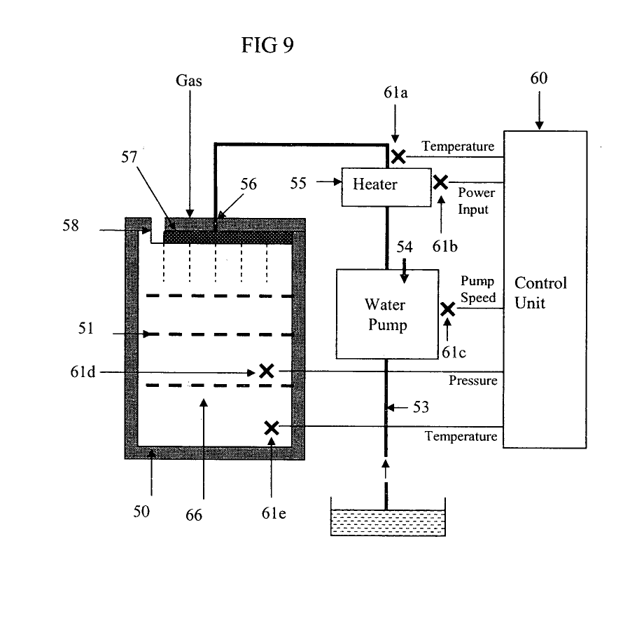

FIG. 9 displays an embodiment of the invention whereby the water to be heated is sourced externally to the vessel. It is further envisaged that an additive may be combined with the liquid in the external reservoir, or in an alternative embodiment the additive may originate from a separate source and may be mixed with the liquid within the system. For example lemon juice or other type of flavouring could be added to the liquid, along with a vitamin and/or mineral additive so as to improve the flavour and/or nutritional content of the foodstuff.

The injection of water into the system, whether at room temperature or heated above room temperature, also contributes to varying the volume in which the gas resides within the sealed container and provides a further means of varying the pressure within the sealed container. It is also practicable to manipulate the desired pressure within the sealed container by a mechanical means so as to adjust the volume in which the gas resides. In addition to varying the number of gas molecules within the sealed container, and adjusting the volume in which the gas molecules reside, the temperature within the sealed container may be adjusted so as to vary and control the pressure within the container. A single pressure regulation technique (as previously described) can be implemented, or alternatively a combination of pressure regulation techniques can be applied.

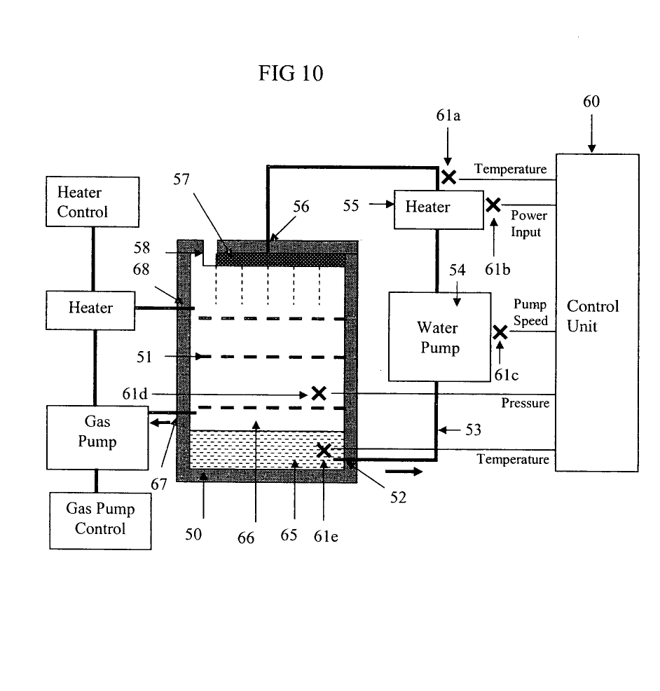

FIG. 10 displays an embodiment whereby the invention includes a gas outlet where the gas sealed within the container is used to increase the pressure in the container. The gas that is originally at room temperature within the sealed container is extracted from the container by a gas pump, this extracted gas is then passed through a gas outlet 67 having a gas valve (not shown), and then circulated through a heating means. Finally, the heated gas is injected into the sealed container via the gas inlet 68.

It is noted that the heated liquid, which originates from the liquid reservoir (whether internal or external to the sealed container), is used to cook the foodstuff. However, there are also contributions to the cooking process from the liquid phase suspended in the gas that is introduced into the container and/or the liquid phase that is present in the foodstuff. For example, in a system where the gas is a spray the following sources contribute to the cooking process: the water that is present in the spray; the water that originates from the reservoir; and the water in the foodstuff itself.

Dependent on the area of use, air within the container also contains a percentage of water giving it a humidity factor. This water content would contribute to the water used to cook the foodstuff. However, for a system that uses nitrogen as the gas and that expelled air from the system, the contribution of water from the gas may be reduced (depending on the purity of the gas source) and the significant cooking contribution associated with liquid phase (for example water) would be from the water contained in the food stuff itself and/or the reservoir.

Since raising the temperature of water above its boiling point consumes energy, it is desirable to avoid changing the state of water in the heating process. This can be achieved by ensuring that the heated liquid does not reach or exceed the boiling point of the liquid.

The injection of gas into a sealed, closed container, the increase of temperature of gas present in the container, or the reduction of volume in which the gas is contained all have the effect of increasing the pressure within the container. This has the effect of increasing the boiling point of the liquid phase e.g. water. Therefore, the foodstuff within the container may be cooked at temperatures above the boiling point of water at atmospheric pressure without reaching the actual boiling point of water at the operating pressure. This is more energy efficient since there is no change of phase of the water in the container. The same principles apply with other types of liquid phase that may be present within the container, for example milk.

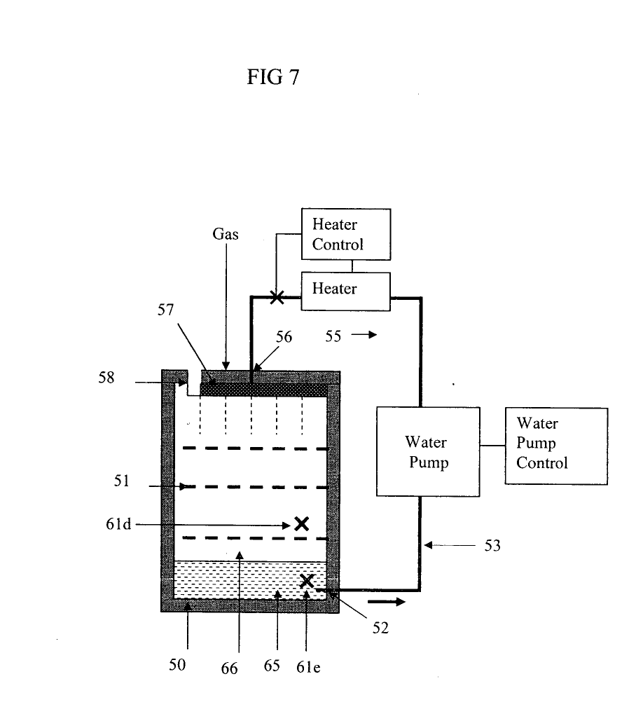

In summary it is highlighted that the following arrangements would permit the cooking device to cook food under pressures other than atmospheric:
i. mist or gas from a source external to the container may be injected directly into the system, bypassing a heating means
ii. pre-heated mist or gas from a source external to the closed container may be injected directly into the container;
iii. mist or gas from a source external to the closed container may be injected into the system at a position prior to the heating means, would pass through the heating means and would then pass into the container as shown in FIG. 7;
iv. mist or gas present in the container and at room temperature may be extracted from the container passed through the heater, where the mist or gas is heated and then the heated mist or gas can be injected into the container as shown in FIG. 6;
v. the mist/gas in the container may be heated prior to being extracted from the container, passed through the tube and then injected back into the container; or
vi. mist or gas from a source external to the closed container may be pumped into the container when the system is in operation causing the mist or gas to follow either option iv) or v).
vii. the temperature within the sealed container may be adjusted so as to adjust and control the internal pressure.
viii. the volume in which the gas inhabits may be adjusted so as to adjust the pressure within the sealed container, this could be achieved by inserting liquid into the container or by mechanical means.

The embodiments of FIG. 6 to FIG. 10 differ from standard pressure cookers, whereby positive pressures are achieved through the build-up of steam, since the pressure is attained much more quickly as it depends on the rate at which the gas is introduced, the volume in which the gas resides is decreased or the temperature internal to the container is increased and, importantly, not on the production of steam in the sealed container. Further, the embodiment of FIGS. 6 to 10 allow for the cooking temperature to be below the boiling point of water, or other liquid phase, at the operating pressure, but above 100° C. (or the boiling point of liquid phase at atmospheric pressure for a given latitude). As an example, suppose the pressure in the sealed container is set such that the boiling point is 110° C. The operating temperature that is set independently may then be chosen at some value below 110° C., for instance 105° C. This is below the actual boiling point of the liquid phase at the operating pressure, but is above the boiling point of water. Therefore, the cooking time for the foodstuff is less because the temperature imparted on the foodstuff is higher than at atmospheric pressure for a given altitude.

FIGS. 7, 8 and 10 display that the control unit may be separated into independent control systems for controlling each variable of the system whereby cross coupling of information may be applied between the independent control systems. For instance the heater temperature control system may communicate with the pressure sensing control system so as to adjust the target temperature of the heater dependent on the selected target pressure of the system. Further feedback loops may be implemented for adjusting the control variables to optimise the cooking time of the foodstuff. For example the target temperature of the water may be set, the water temperature monitored and adjusted as necessary by increasing or decreasing the power to the heater means as appropriate. In a preferred embodiment the system utilises two temperature feedback loops and a pressure feedback loop. A microprocessor could be implemented to control individual or combinations of loops.

In an alternative embodiment of the invention the fluid heating medium is a gas and the heater is arranged so as not to increase the temperature of the gas to the boiling point of the water contained within the foodstuff at operating pressure.

The invention provides, in various aspects, for below boiling point water to be used for cooking of foodstuffs, preferably by means of close temperature control of a heating element and in which forced pumping or agitation of the liquid can have enhanced technical effects. The agitation technique can have efficacy in conventional boiling water techniques to produce enhanced and controlled degree agitation.

Furthermore, benefits may be obtained when the cooking device operates under pressures above atmospheric pressure for a given latitude since this achieves actual temperatures that are higher than the boiling point of the liquid phase at atmospheric pressure for a given latitude, but lower than the actual boiling point of the liquid phase at the operating pressure. This causes the cooking period of the foodstuff to be reduced. The warm up period is also quicker due to the insertion of gas into the system and the heating of water near to the spray head. Therefore, the overall cooking time of the foodstuff is reduced.

It should be noted that the above-mentioned embodiments illustrate rather than limit the invention, and that those skilled in the art will be capable of designing alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. A food heating system comprising:
a container within which the food is to be heated;
heater means for heating either or both of the food present in the container or a fluid heating medium present in the container, at least part of either or both of the food or the fluid heating medium present in the container being in the liquid phase;
control means for controlling the heater means so as to not raise the temperature of the fluid heating medium to the boiling point of the liquid phase of the food or fluid heating medium present in the container.

2-8. (canceled)

9. A food heating system comprising:
a container for containing liquid and being heated; and
agitating means for agitating the liquid in the container whilst being heated.

10-34. (canceled)

35. A method of heating food in which liquid is heated in a container, the liquid being maintained at a temperature below the boiling point of the liquid, and the liquid is agitated by an agitation means.

36-38. (canceled)

39. A method of heating food in which
at least part of either or both of the food present in a container or a fluid heating medium present in a container being heated,
at least part of either or both of the food present in the container or the fluid heating medium in the container being in the liquid phase, and
the fluid heating medium being maintained at a temperature below the boiling point of the liquid present in the container.

40-57. (canceled)

58. A food heating system according to claim 1, further including:
agitating means for agitating the liquid phase in the container.

59. A food heating system according to claim 58, wherein:
the agitating means comprises means for directing an agitating gas or other fluid under pressure into the container to agitate the liquid phase in the container, preferably into the container in the region of the base of the container, at least below the level of the liquid present in the container.

60. A food heating system according to claim 1, wherein:
said control means is arranged to inhibit the temperature of the heating element from reaching the boiling point of the liquid in the container, wherein the control means is preferably arranged to operate the heater element to maintain the temperature of the liquid phase at or above a predetermined threshold, preferably wherein the control means is arranged to operate the heater element to maintain the temperature of the liquid at or above a level 20° C. below the boiling point of the liquid, preferably wherein the control means is arranged to operate the heater element to maintain the temperature of the liquid at or above a level 10° C. below the boiling point of the liquid.

61. A food heating system according to claim 1, further including at least one of:
a) distribution means for distributing the liquid over the surface of foodstuff present in the container;
b) a food receiving receptacle is located within the container, and a liquid distribution arrangement directs the liquid to flow over a side of the food receiving receptacle and through a percolation element;
c) one or more conduits for raising the liquid from a lower portion of the container to be distributed from above the food heating zone, preferably the one or more conduits are defined at the periphery of the liquid distribution arrangement.

62. A food heating system according to claim 61, wherein:
the food receiving receptacle is located within the container, and the distribution means comprises a conduit in the form of an annular space between the food receiving receptacle and the container.

63. A food heating system according to claim 1, wherein:
the container is at least one
a) closed and sealed, and capable of withstanding pressures above and/or below atmospheric pressure for a given altitude; and
b) thermally insulated.

64. A food heating system according to claim 1, further including at least one of:
a) an arrangement for increasing the pressure internal to the container; preferably in combination with control means arranged to control the pressure within the container;
b) an inlet located in at least one side of the container and positioned above the foodstuff for permitting the injection of the fluid heating medium into the container and causing the fluid heating medium to pass over the surface of the foodstuff; and
c) an outlet located in at least one side of the container for permitting the extraction of the fluid heating medium from the container, preferably including a conduit arranged between the outlet and the inlet to direct the fluid heating medium there between and preferably a pump for pumping the fluid heating medium through the fluid heating medium transporting means.

65. A food heating system according to claim 1, further including at least one of:
a) a spray head for mixing gas and fluid heating medium;
b) a gas inlet for permitting the injection of gas into the container;
c) a mechanical adjuster for adjusting the volume within the container.

66. A food heating system according to claim 1, further including at least one of:
a) means for increasing the volume of the liquid phase within the container;
b) a further heating arrangement for heating the gas and or liquid contained within the container;
c) a controller for controlling one or more parameters of the system, preferably including at least one sensing means for sensing a parameter of the system, for example temperature, pressure or flow rate, and transmitting a signal representative of the measured parameter to the controller.

67. A method of heating food according to claim 35, wherein:
the liquid is agitated by delivering one of a pressurized fluid and an agitating gas stream into the liquid from an external source.

68. A method of heating food according to claim 39, wherein:
pressure within the container is higher than atmospheric pressure outside of the container.

69. A method of heating food according to claim 68, wherein pressure within the container is controlled according to at least one of the following operations:
a) pressure increase within the container is caused by the injection of gas particles into the container;
b) pressure increase within the container is caused by decreasing the volume within the container; and
c) pressure increase in the container is caused by increasing the temperature of gas present within the container.

70. A method of heating food according to claim 39, wherein:
the fluid heating medium is removed from the container prior to being heated.

71. A method of heating food according to claim 39, herein:
the fluid heating medium is re-circulated through a heater until the time at which the food stuff is cooked.

72. A method of heating food according to claim 39, wherein:
a predetermined amount of fluid heating medium is injected into the container via a heater means or a predetermined amount of pre-heated fluid heating medium is injected into the container.

73. A method of heating food according to claim 72, wherein:
the fluid heating medium is replenished when the temperature within the sealed container falls below a threshold value.

74. A method of heating food according to claim 39, wherein:
the fluid heating medium is in the gaseous phase or is gas comprising droplets of liquid phase.

75. A method of heating food according to claim 74, wherein:
the fluid heating medium is in the gaseous phase;
the gaseous phase is stored within a closed container;
the gaseous phase is pumped out of the closed container prior to being heated by a heater means; and
the heated gaseous phase is returned to the closed container and then distributed over the surface of foodstuff present within the closed container.

76. A method of heating food according to claim 74, wherein:
the fluid heating medium is in the gaseous phase; and
the temperature of the gaseous phase is maintained at a temperature below the boiling point of water contained in the foodstuff
